(19) United States
(12) Patent Application Publication
(10) Pub. No.: US 2023/0253912 A1
(43) Pub. Date: Aug. 10, 2023

(54) Photovoltaic Electricity Generation Unit

(71) Applicant: Robert Koziol, Mena, AR (US)

(72) Inventor: Robert Koziol, Mena, AR (US)

(21) Appl. No.: 18/108,559

(22) Filed: Feb. 10, 2023

Related U.S. Application Data
(60) Provisional application No. 63/267,828, filed on Feb. 10, 2022.

(51) Int. Cl. H02S 10/40; H02S 20/30; H02S 30/20; H02S 40/34

(52) U.S. Cl. CPC H02S 10/40; H02S 20/30; H02S 30/20; H02S 40/34

(57) ABSTRACT

A photovoltaic electricity generation unit is disclosed. The photovoltaic electricity generation unit includes a power unit having at least one photovoltaic array configured to output DC electrical power. The photovoltaic array is foldably supported by a frame assembly. The frame assembly includes a base frame operatively associated with ground engaging elements to be portable by a user, a plurality of support members extending upwardly from the base frame, and a plurality of intermediate frames foldably mounted on the plurality of support members. A control unit having a controller accommodated inside a housing mounted on the frame assembly is configured to receive the DC electrical power from the power unit and output AC electrical power to the load system.

### CROSS-REFERENCE TO RELATED APPLICATIONS

This application claims priority to U.S. Provisional Application No. 63/267,828 filed on Feb. 10, 2022, which is fully incorporated herein by reference.

### STATEMENT REGARDING FEDERALLY SPONSORED RESEARCH OR DEVELOPMENT

Not applicable.

### BRIEF DESCRIPTION OF THE DRAWINGS

FIG. 1 is a perspective view showing the photovoltaic electricity generation unit of an embodiment of the present invention in an unfolded state.

FIG. 2 is a perspective view showing the photovoltaic electricity generation unit of an embodiment of the present invention partially folded state.

FIG. 3 is a perspective view showing the photovoltaic electricity generation unit of an embodiment of the present invention fully folded.

FIG. 4 is a perspective view showing the photovoltaic electricity generation unit of an embodiment of the present invention excluding the photovoltaic arrays.

FIG. 5 is a rear view showing the photovoltaic electricity generation unit of an embodiment of the present invention.

FIG. 6 is a schematic illustration showing an exemplary control unit of the photovoltaic electricity generation unit of an embodiment of the present invention.

### BACKGROUND DISCUSSION

Many americans rely on photovoltaic systems for electricity. These systems may, for example, be embodied by an array of photovoltaic modules which generate electricity to power electrical systems, such as the electrical system of a house, by converting photons to electrical power. In the context of housing, these systems are often fixedly mounted on a house, which may be aesthetically undesirable to a user or be subject to limited sunlight exposure. The photovoltaic electricity generation unit of the present disclosure solves such issues.

### SUMMARY

One aspect of the present invention is directed to a photovoltaic electricity generation unit that includes a power unit having at least one photovoltaic array configured to output DC power, and a control unit having a controller configured to receive the DC power and output an AC power signal to a load system. The at least one photovoltaic array is foldably and portably supported by a frame assembly. The frame assembly includes a base frame portably supported by ground engaging elements, one or more support members extending upwardly from base frame, and a plurality of intermediate frames foldably mounted on the one or more support members, the at least one photovoltaic array being securely fitted in the plurality of intermediate frames. The power unit may include at least one power storage device to store and output DC power, and an external electrical grid can be optionally incorporated in the power unit through an input terminal mounted on the frame assembly.

Another aspect of the present invention is directed to a frame assembly for mounting photovoltaic modules. The frame assembly includes a base frame portably supported by ground engaging elements, a plurality of support members extending upwardly from base frame, and a plurality of intermediate frames foldably mounted on the one or more support members. The intermediate frames may be embodied by a center intermediate frame fixedly mounted to and between the plurality of support members, and by a plurality of outer intermediate frames rotatably mounted to the plurality of support members, the plurality of outer intermediate frames being configured to rotate to and between an unfolded state and a folded state. Handles may also be attached to handle appendages mounted on the base frame to be grasped by a user when moving the frame assembly.

### DETAILED DESCRIPTION

Various exemplary embodiments of the present invention will be disclosed hereinafter with frequent reference to the drawings. For simplicity and clarity of illustration, elements indicated in the drawings are not necessarily drawn to scale, and reference labels have been repeated thereamong to indicate analogous elements. Each embodiment is disclosed for the purpose of enabling persons of ordinary skill in the art to appreciate and understand the principles and practices of the present invention. It is to be understood, however, that all of such embodiments are merely examples and not intended to limit the scope of the present invention.

The present invention is directed generally to a photovoltaic (“PV”) electricity generation unit 100. PV electricity generation unit 100 functions to power one or more load system(s). A load system may include an electrical system configured to be powered by AC electrical power or DC electrical power. For simplicity, unless the context of this specification clearly indicates otherwise, PV electricity generation unit 100 may hereinafter be described with regard to a primary load system. The primary load system may be embodied by an AC electrical system of a residential building having a local electrical distribution panel electrically interconnected with conventional electrical outlets through which lighting equipment, HVAC equipment, electronics, appliances, and/or other common household devices and equipment may be powered. Such an electrical system is typically configured to be powered by an external electrical grid 116, which outputs electrical power at a voltage of 120/240 VAC at a frequency of 50 Hz or 60 Hz. As will be more fully described herein, embodiments of PV electricity generation unit 100 may generate electrical power at a voltage of 120/240 VAC at a frequency of 60 Hz and output it as a primary operating power signal. The local electrical distribution panel of the primary load system may be electrically connected to PV electricity generation unit 100 via conductive link 156 to receive the primary operating power signal. It is contemplated that PV electricity generation unit 100 may be embodied with various changes and modifications so as to function to generate a power signal sufficient to power other AC and/or DC electrical systems. For example, PV electricity generation unit 100 may also be configured to generate electrical power at a voltage of 120 VAC at a voltage of 60 Hz and output it to one or more secondary load system(s) as a secondary operating power signal. A secondary load system may be embodied by an electronic device or equipment with a DC electrical system capable of otherwise being powered through conventional electrical outlets of the primary load system, such as electronics, appliances, electric power tools, or other electronic devices or equipment.

PV electricity generation unit 100 includes a power unit 110, a control unit 130, and a frame assembly 120. As will be described more fully herein, power unit 110 includes various electrical power sources from which electrical power may be output to control unit 130 in the form of power signals. Power unit 110 includes one or more PV array(s) 112a1, 112a2 as an off-grid electrical power source (PV array(s) 112a1, 112a2 may be referred to herein collectively as “PV array(s) 112,” or individually as a “PV array 112,” when unnecessary to distinguish therebetween). PV array(s) 112 function to generate electrical power based on photons received from a light source, such as the sun. Preferably, power unit 110 also incorporates power storage device(s) 114 for storing electrical power, which can be used as an alternative off-grid electrical power source. Power storage device(s) 114 may be constituted by battery cells, such as lead-acid, lithium-ion, nickel-cadmium, nickel metal hydride, or molten salt battery cells. According to one embodiment, for example, power storage device(s) 114 are constituted by 12-volt, lead-acid battery cells electrically connected in series so as to collectively store and output electrical power at 48 VDC. External electrical grid 116 may be optionally incorporated in power unit 110. For example, external electrical grid 116 may be electrically connected to control unit 130 through an electrical grid input terminal 138 of control unit 130 via conductive link 154.

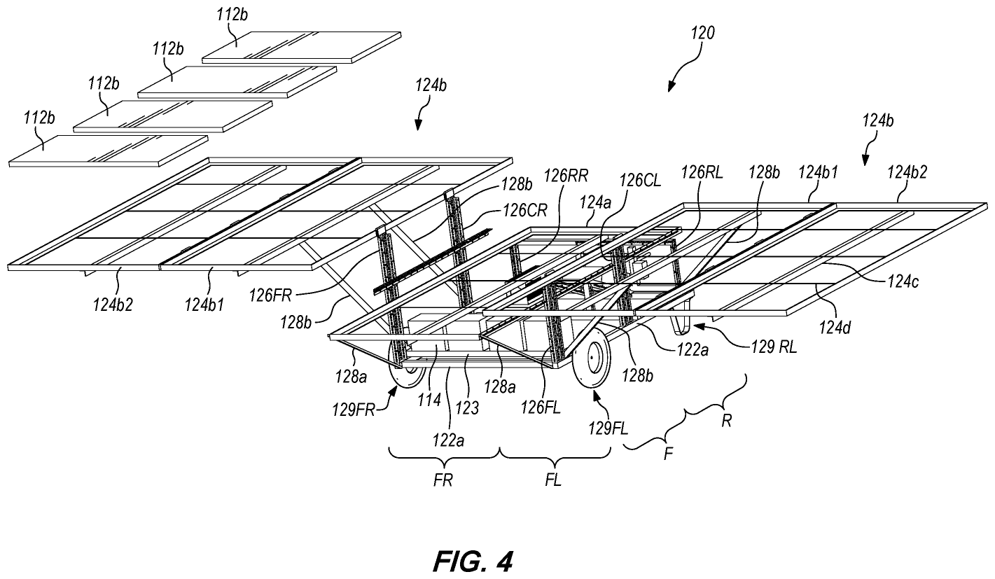

PV array(s) 112 may be characterized by a center PV array 112a1 and a plurality of outer PV arrays 112a2. Each PV array 112 includes one or more PV module(s) 112b. PV module(s) 112b function to convert photons into electrical power having a DC voltage. PV module(s) 112b may be embodied by one or more PV panel(s), solar module(s) and/or panel(s), or glass or glass-to-glass module(s) and/or panel(s). Each PV module 112b typically converts photons into electrical power at a voltage of 18 VDC under standard temperature, lighting, and air mass conditions (e.g., 25° C., 1000 W/m², and air mass 1.5), but may be configured to generate electrical power at higher or lower voltage or current so as to be suitable for powering a variety of load systems. Each PV module 112b typically includes multiple layers for converting photons into electrical power, including, for example, a back layer, a cover layer, encapsulant layers, and a PV layer. A “layer,” as used herein, broadly means a sheet, layer, film, planar coating, or other planar-shaped article, or any link(s), contact(s), strip(s), paste(s), or intermediate article(s) applied to a top or bottom side of such planar-shaped article. The layers of a PV module(s) 112b may define a four-sided, rectangular-shaped module, as illustrated in FIG. 4. It is to be understood, however, that PV modules 112b may each be formed of layers of any number of sides, shapes, and sizes, so long as each of them are of sufficient size and shape to be securely fitted within intermediate frames 124.

The encapsulant layers of each PV module 112b function to protect its PV layer against damage caused by debris and environmental conditions (such as moisture) and to facilitate the adherence of its PV layer to its cover layer and back layer. For example, the encapsulant layers may be adhered respectively to top and bottom surfaces of the PV layer such that the PV layer is encapsulated between the encapsulant layers. Each encapsulant layer may be made of a thermoplastic polymer or other material with sufficient adhesive and transparent properties, such as polyethylene, polyvinyl chloride, or ethylene vinyl acetate.

The PV layer of each PV module 112b functions to receive photons from the light source and convert the photons into electrical power. Each PV layer includes a plurality of PV cells electrically interconnected via conductive links (such as metal strips and/or solder). Each PV cell may comprise further layers, including, for example, an antireflective layer, conductive layers, and a semiconductor layer. The semiconductor layer may be interposed between the conductive layers. The semiconductor layer may be defined by top, middle, and bottom layers made of semiconductor material, such as crystalline silicon (e.g., monocrystalline or polycrystalline silicon), ribbon silicon, gallium arsenide, cadmium telluride, copper indium gallium selenide, or any other semiconductor material known in the art to be suitable for converting photons into electrical power. In a preferred embodiment, the semiconductor layer may be made of monocrystalline silicon, which can be more conducive to the transfer of electrons necessary to generate electrical power. The top layer may be formed of an n-type semiconductor material (i.e., a semiconductor material doped with phosphorus, arsenic, antimony, or any other suitable trivalent impurity), and the bottom layer may be formed of a p-type semiconductor material (i.e., a semiconductor material doped with boron, indium, or any other suitable pentavalent impurity). The middle layer may be interposed between the top and bottom layers to induce a transfer of electrons within the semiconductor layer in response to photons received from the light source.

The conductive layers include a top conductive layer and a bottom conductive layer made of material with high electrical conductivity, such as silver, aluminum, or a silver alloy. The bottom conductive layer may be constituted by a planar-shaped plate secured to a bottom surface of the semiconductor layer. The top conductive layer may be constituted by strips, links, or a sufficiently transparent paste operably associated with the top surface of the semiconductor layer such that the top surface is exposed or exposable to photons emitted by the light source. In various embodiments, for example, the top conductive layer is constituted by silver strips or links interconnected and applied to the top surface of the semiconductor layer in a grid formation.

In operation, photons may pass through the top layer of the semiconductor layer to the middle layer to induce a transfer of electrons among the top, middle, and bottom layers of the semiconductor layer, thereby generating electrical power. The top surface of the semiconductor layer may have reflective properties that reflect a portion of the photons away from the semiconductor layer, which can reduce the amount of electrical power generated by the semiconductor layer. In this regard, the top surface of the semiconductor layer may be texturized via etching to alter the angle at which photons are reflected such that they reflect into another area of the top surface of the semiconductor layer. As an alternative or supplement to such texturizing, an antireflective layer may be applied to the top surface of the semiconductor layer to desynchronize the wavelengths of the reflected photons. The antireflective layer is typically made of a dielectric material, such as titanium, titanium dioxide, titanium nitride, chromium oxide, carbon, silicon nitride, or any other suitable dielectric material known in the art.

The cover layer and the back layer of each PV module are provided to enclose its encapsulant layers and PV layer. Each back layer may be embodied by a planar sheet made of a metal, alloy, polymer, or polymeric blend, such as polyvinyl fluoride. Each back layer is typically opaque, but a person of ordinary skill in the art can appreciate that back layers may be transparent in various embodiments. Each cover layer may be formed of glass, such as window glass, plate glass, silicate glass, sheet glass, tempered glass, untempered glass, float glass, colored glass, or any other suitable type of standard or specialty glass. As an alternative to glass, the cover layer may be made of a polymer or other material with high transparency to allow sufficient photons to pass to the PV layer as described herein.

PV array(s) 112 are each preferably formed by a plurality of PV modules 112b electrically connected in series via conductive links. Further, each PV array 112 may be electrically connected in series with one or more of the other PV array(s) 112 so as to constitute a single, combined array, or one or more PV array(s) 112 may be separate from the other PV array(s) 112 so as to constitute multiple arrays. When PV array(s) 112 are constituted as multiple arrays, one or more junction(s) 132j may be provided as part of control unit 130 to combine the multiple arrays and output the electrical power generated by them collectively to other components of control unit 130 as a power signal. In various embodiments, for example, PV array(s) 112 are combined to output a power signal containing electrical power at or nearly at a voltage of 430 VDC, depending on factors such as the output rating and efficiency of PV module(s) 112b and environmental conditions (such as temperature and irradiation).

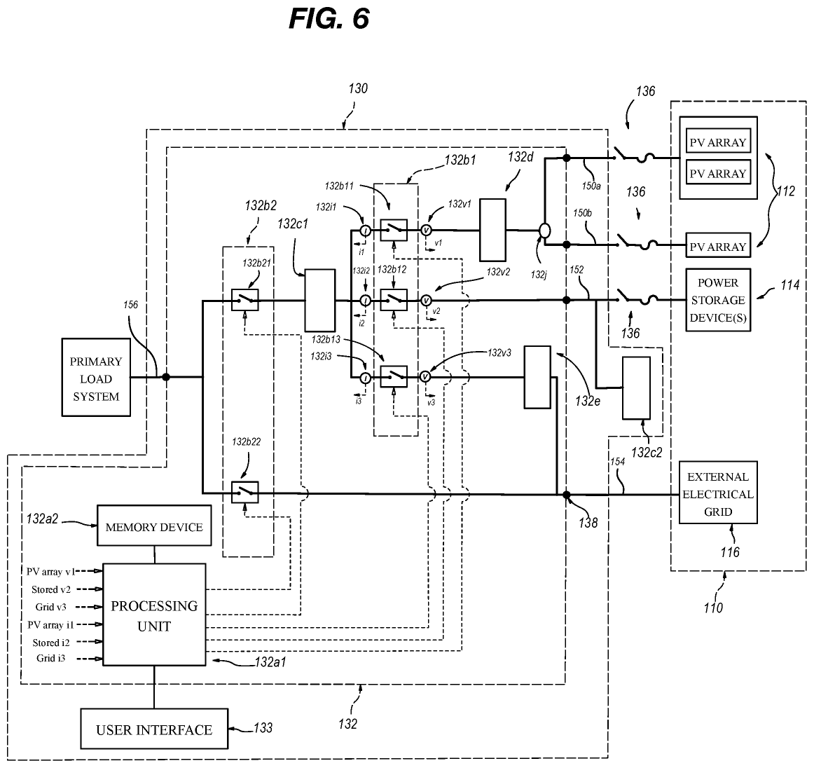

FIG. 6 illustrates a schematic representation of an embodiment of PV electricity generation unit 100 showing an exemplary control unit 130. As illustrated, PV array(s) 112 and power storage device(s) 114 of power unit 110 may be electrically connected to control unit 130 via conductive links 150a, 150b, 152 to output electrical power to control unit 130 in the form of power signals. Optionally, as noted, external electrical grid 116 may be incorporated in power unit 110 by electrically connecting it to control unit 130 via conductive link 154. Conductive links 150a, 150b, 152, 154 may be constituted by one or more electrically-conductive wires, cables, or other forms of wired connections through which electrical power can be transferred. One or more circuit breaker(s) 136 may be disposed respectively in one or more of conductive link(s) 150a, 150b, 152, as shown in FIG. 6, to control the outputting of power signals from the various off-grid power sources of power unit 110 to control unit 130. For example, circuit breaker(s) 136 may each include a fuse configured to disconnect an off-grid power source from control unit 130 upon electrical power being supplied therethrough at a voltage in excess of a predetermined threshold voltage, which may prevent damage to components of control unit 130 as a result of excessive voltage. Circuit breaker(s) 136 may also each include a switch by which a user may selectively set on and off the power signals output by power storage device(s) 114 or PV array(s) 112 to control unit 130.

Control unit 130 receives the power signals from power unit 110 and, based thereon, generates one or more operating power signal(s) for powering the load system(s). Control unit 130 includes controller 132, a controller housing 131, and a user interface 133. Controller housing 131 may be formed of a metal, alloy, and/or polymer container that defines an inner cavity. Controller 132 may be mounted on a printed board accommodated in the inner cavity of controller housing 131. Controller 132 may be embodied by hardware resources for storing and executing software instructions, including, for example, a processing unit 132a1, such as a central processing unit (“CPU”) or microprocessing unit (“MPU”), a memory device 132a2, such as a random access memory (“RAM”) or read only memory (“ROM”), input terminals, output terminals, and a plurality of peripherals (e.g., DC-DC converter, inverter, switches, rectifier, sensors, comparators and the like). Software instructions may be stored in memory device 132a2 of controller 132 and referenced by processing unit 132a1 to control the peripherals of controller 132 to perform several operations for generating a consistent primary operating power signal, such as interconnecting the primary load system with the various power sources of power unit 110, inverting voltages, rectifying voltages, and/or regulating the electrical power stored in power storage device(s) 114.

For simplicity, the peripherals of controller 132 will be described hereinafter with regard to the schematic representation of the embodiment of FIG. 6, but it is contemplated that the peripherals of controller 132 may embodied by any other configuration of peripherals capable of being controlled by processing unit 132a1 to execute the operations of controller 132. Referring to the embodiment of FIG. 6, as illustrated, peripherals of controller 132 may include a DC-DC converter 132d, a primary inverter 132c1, voltage sensors 132v1-132v3, and switch matrixes 132b1, 132b2. Switch matrix 132b2 comprises switches 132b21, 132b22. External electrical grid 116 may be electrically connected to the primary load system through switch 132b22 of switch matrix 132b2, and off-grid power sources (e.g., PV array(s) 112 and power storage device(s) 114) may be electrically connected to the primary load system through switch 132b21 of switch matrix 132b2. External electrical grid 116 may output a grid power signal to switch 132b22 containing electrical power at 120/240 VAC at a frequency of 60 Hz. Off-grid power sources may output an off-grid power signal to switch 132b21 generated through primary inverter 132c1. Primary inverter 132c1 functions to generate the off-grid power signal based on an off-grid power supply signal received from PV array(s) 112 or power storage device(s) 114. Power storage device(s) 114 may be electrically connected to primary inverter 132c1 through switch 132b12 of switch matrix 132b1, and PV array(s) 112 may be electrically connected to primary inverter 132c1 through switch 132b11 of switch matrix 132b1. PV array(s) 112 may output a power signal to or from switch 132b11 through DC-DC converter 132d, for example, to improve such power signal for operations of controller 132. External electrical grid 116 may be electrically connected to power storage device(s) 114 through switch 132b13 of switch matrix 132b1 and a rectifier 132e for adding electrical power from external electrical grid 116 to power storage device(s) 114.

Voltage sensors 132v1-132v3 and current sensors 132i1-132i3 may be disposed at switches 132b11-132b13 of switch matrix 132b1 to monitor the voltage and current of power signals output respectively to switches 132b11-132b13 from PV array(s) 112, power storage device(s) 114, and external electrical grid 116. Switch matrixes 132b1, 132b2, voltage sensors 132v1-132v3, and current sensors 132i1-132i3 are in communication with processing unit 132a1 of controller 132 such that, in accordance with the software instructions stored in memory device 132a2, processing unit 132a1 can control the opening and closing of switches 132b11-132b13, 132b21, 132b22 of switch matrixes 132b1, 132b2 based on the voltages detected by voltage sensors 132v1-132v3. By opening and closing switches 132b11-132b13, 132b21, 132b22 according to the software instructions stored in memory device 132a2, PV electricity generation unit 100 can be automatically operated in various modes to facilitate the consistency of the primary operating power signal output to the primary load system. For example, PV electricity generation unit 100 can be operated in one of a first off-grid operation mode, a second off-grid operation mode, and a grid operation mode depending on the voltages detected by voltage sensors 132v1 and 132v2.

The various exemplary alternative operation modes of PV electricity generation unit 100 will hereinafter be described with regard to FIG. 6. PV electricity generation unit 100 may be operated in the first off-grid operation mode when PV array(s) 112 output a power signal through DC-DC converter 132d at a voltage sufficient to power the primary load system through primary inverter 132c1, such as 48 VDC or nearly 48 VDC. Upon voltage sensor 132v1 detecting a power signal output from PV array(s) 112 at a voltage sufficient to power the primary load system through primary inverter 132c1, processing unit 132a1 of controller 132 may control switch matrixes 132b1, 132b2 to begin operating PV electricity generation unit 100 in the first off-grid operation mode. In the first off-grid operation mode, processing unit 132a1 may close switch 132b11 of switch matrix 132b1 to output a power signal from PV array(s) 112 to primary inverter 132c1 through DC-DC converter 132d as the off-grid power supply signal. Primary inverter 132c1 may include a waveform generator which is activated in the first off-grid operation mode. Primary inverter 132c1 may generate an off-grid power signal by converting the DC voltage of the off-grid power supply signal to AC voltage following the phase of the waveform generator, typically 50 Hz or 60 Hz pure sine wave. The off-grid power signal is output from primary inverter 132c1 to switch 132b21 of switch matrix 132b2, and processing unit 132a1 of controller 132 may close switch 132b21 to output the off-grid power signal to the primary load system as the primary operating power signal.

If PV array(s) 112 output a power signal at a voltage greater than required to power the primary load system through primary inverter 132c1, processing unit 132a1 of controller 132 may close switch 132b12 of switch matrix 132b1 to output the power signal from PV array(s) 112 to power storage devices 114 through DC-DC converter 132d as a charging signal, thereby storing electrical power in power storage device(s) 114. DC-DC converter 132d functions to facilitate the storing of electrical power from PV array(s) 112 in power storage device(s) 114. DC-DC converter 132d, for example, may include at least one inductor, capacitor, and switching devices (e.g., transistors, diodes, etc.) electrically interconnected in a buck and/or boost circuit configuration. Processing unit 132a1 of controller 132 may control the opening and closing of the switching devices of DC-DC converter 132d (typically a metal-oxide-semiconductor field effect transistor, or “MOSFET,” and a diode) to modulate the current and voltage of the power signal of PV array(s) 112. In operation, for example, by opening and closing the switching devices of DC-DC converter 132d, the power signal may be alternatingly stored in the inductor and discharged to power storage device(s) 114 as the charging signal according to software instructions stored in memory device 132a2.

Software instructions for executing a maximum power point tracking algorithm (e.g., a perturbation and observation algorithm, incremental conductance algorithm, fractional open circuit voltage algorithm, etc.) may be stored in memory device 132a2 of controller 132 and referenced by processing unit 132a1 of controller 132 to control DC-DC converter 132d so as to enhance the charging signal output to power storage device(s) 114. For example, according to such software instructions, processing unit 132a1 of controller 132 may control the switching device(s) of DC-DC converter 132d to modulate the voltage and current of the power signal output by PV array(s) 112 to match or nearly match that of the maximum power point of PV array(s) 112. The “maximum power point” of PV array(s) 112, as used herein, is the maximum electrical power capable of being output by PV array(s) 112 at a given instant according to the power curve of PV array(s) 112. The maximized power signal may be output from DC-DC converter 132d to power storage device(s) 114 as the charging signal until power storage device(s) 114 reach a maximum voltage capacity. If voltage sensor 132v2 detects a power signal output from power storage device(s) 114 at a voltage equal to or exceeding the maximum voltage capacity of power storage device(s) 114, processing unit 132a1 may open switch 132b12 of switch matrix 132b1 to stop outputting the charging signal from PV array(s) 112 to power storage device(s) 114. Alternatively, processing unit 132a1 may switch PV electricity generation unit 100 to the second off-grid operation mode to discharge excess electrical power stored in power storage device(s) 114 to the primary load system via primary inverter 132c1.

PV electricity generation unit 100 may also be operated in the second off-grid operation mode when PV array(s) 112 output a power signal at a voltage insufficient to power the primary load system through primary inverter 132c1, which may occur, for example, when the photon exposure of PV array(s) 112 is substantially reduced as a result of dense overcast, darkness, or other conditions of the ambient environment. Upon voltage sensor 132v1 detecting a power signal output from PV array(s) 112 at a voltage insufficient to power the primary load system through primary inverter 132c1, processing unit 132a1 may control switch matrixes 132b1, 132b2 to begin operating PV electricity generation unit 100 in the second off-grid operation mode. In the second off-grid operation mode, processing unit 132a1 of controller 132 may close switch 132b12, and open switches 132b12 and 132b13, of switch matrix 132b1 to output the power signal of power storage device(s) 114 to primary inverter 132c1 as the off-grid power supply signal. Similar to the first off-grid operation mode, primary inverter 132c1 may generate the off-grid power signal by converting the off-grid power supply signal from DC voltage to AC voltage following the phase of the waveform generator. The off-grid power signal is output from primary inverter 132c1 to switch 132b21 of switch matrix 132b2, and processing unit 132a1 of controller 132 may close switch 132b21 to output the off-grid power signal to the primary load system as the primary operating power signal.

Continuous operation of PV electricity generation unit 100 in the second off-grid operation mode can eventually deplete the electrical power stored in power storage device(s) 114 such that power storage device(s) 114 output a power signal at a voltage less than required to power the primary load system or less than a minimum voltage capacity. According to the software instructions stored in memory device 132a2, processing unit 132a1 of controller 132 may control switch matrixes 132b1, 132b2 to begin operating PV electricity generation unit 100 in the grid operation mode upon voltage sensors 132v1, 132v2 detecting power signals output from PV array(s) 112 and power storage device(s) 114 at voltages less than required to power the primary load system through primary inverter 132c1. In the grid operation mode, processing unit 132a1 of controller 132 may close switch 132b22, and open switch 132b21, of switch matrix 132b2 to disconnect the off-grid power sources from the primary load system and output the grid power signal from external electrical grid 116 directly to the primary load system as the primary operating power signal. Processing unit 132a1 may also close switches 132b12 and 132b13 of switch matrix 132b1 to add electrical power from external electrical grid 116 to power storage devices 114 through rectifier 132e. As can be appreciated by a person of ordinary skill in the art, rectifier 132e may include one or more diode(s) arranged in a bridge circuit configuration or other suitable circuitry to convert the AC voltage of the grid power signal into a DC voltage suitable to store in power storage device(s) 114. The converted grid power signal may be output from rectifier 132e to power storage device(s) 114 as a charging signal until power storage device(s) 114 reach maximum voltage capacity. If voltage sensor 132v2 detects a power signal output from power storage device(s) 114 at a voltage equal to or exceeding the maximum voltage capacity of power storage device(s) 114, processing unit 132a1 may open switch 132b13 of switch matrix 132b1 to stop outputting the charging signal from external electrical grid 116 to power storage device(s) 114. Alternatively, processing unit 132a1 may switch PV electricity generation unit 100 to the second off-grid operation mode to discharge excess electrical power stored in power storage device(s) 114 to the primary load system through primary inverter 132c1.

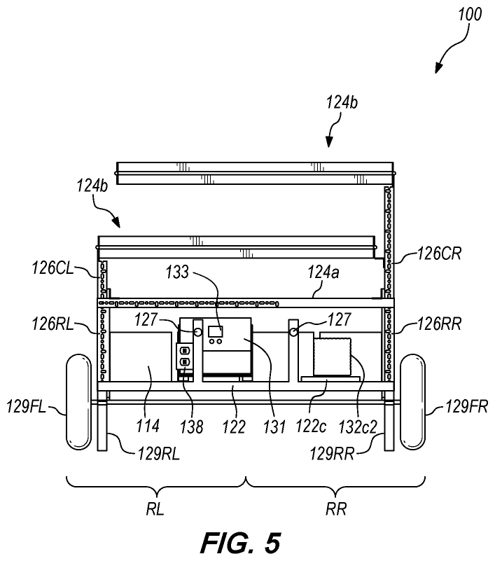

In various embodiments, control unit 130 may include a secondary inverter 132c2. Secondary inverter 132c2 functions to convert the DC voltage of the power signal input to or output from power storage device(s) 114 into an AC voltage and output the converted power signal to one or more secondary load system(s) as the secondary operating power signal. Secondary inverter 132c2, as illustrated in FIG. 5, may be formed separately from controller 132. For example, secondary inverter 132c2 may include an inverter housing and inverter controller. The inverter housing may embody a metal, alloy, or polymer container that defines an inner cavity in which the inverter controller is accommodated. The inverter controller includes hardware resources for storing and executing software instructions, including, for example, a processing unit, such as a CPU or MPU, a memory device, such as a RAM or ROM, input terminals, output terminals, and a plurality of peripherals (e.g., transistors, sensors and the like). It is contemplated that the inverter controller may alternatively be embodied by any other circuitry known in the art to be suitable for converting a DC power signal into an AC power signal sufficient to power the secondary load system(s). Input terminals of the inverter controller may be electrically connected to terminals of controller 132 with power storage device(s) 114 to receive power signals input to or output from power storage device(s) 114. Output terminals of the inverter controller of secondary inverter 132c2 may define slots, sockets, or the like configured to removably engage with input terminals, such as prongs or pins, of conductive links through which the secondary load system(s) may be electrically connected to secondary inverter 132c2. For example, an electronic device can be electrically connected to secondary inverter 132c2 via an electric cable incorporated in the device.

Controller 132 may be in communication with user interface 133 to receive user input indicative of operating parameters of controller 132, such as operating parameters of primary inverter 132c1. User interface 133 may be embedded in or mounted on a surface of controller housing 131. User interface 133 includes at least one input device configured to receive user input. Each input device may be embodied by a knob, dial, wheel, lever, button, touch-screen display, or any other device capable of receiving user input, which generally has indicia that signifies operating parameters of controller 132. User interface 133 may also include at least one output device, such as a display, speaker, or any other device capable of presenting output information that signifies, for example, operating parameters of controller 132. A user may manipulate the input device(s) of user interface 133 to set operating parameters of controller 132 and monitor operating parameters of controller 132 through the output device(s) of user interface 133.

As noted, PV electricity generation unit 100 includes a frame assembly 120. FIG. 4 illustrates an exemplary frame assembly 120. Frame assembly 120 functions to portably support PV array(s) 112, power storage device(s) 114, control unit 130 above a ground surface, such as soil, asphalt, concrete, or other sufficiently solid terrain. As shown in FIG. 4, frame assembly 120 generally includes a base frame 122, ground engaging elements 129, and intermediate frames 124.

Base frame 122 may include a plurality of elongated polymer, wood, alloy, or metal frame members 122a (e.g., aluminum or steel rods, rails, bars, or the like), support beams 122b, support plates 122c, and a controller mount 122d. Elongated frame members 122a of base frame 122 may be interconnected so as to form a four-sided rectangular frame shape having an open inner portion. It is contemplated, however, that elongated frame members 122a may alternatively be embodied and interconnected to form a frame shape having any number of sides, shapes, and sizes capable of supporting PV array(s) 112, power storage device(s) 114, and control unit 130 as described herein. Support beam(s) 122b may be mounted on elongated frame members 122a so as to extend across the open inner portion of base frame 122.

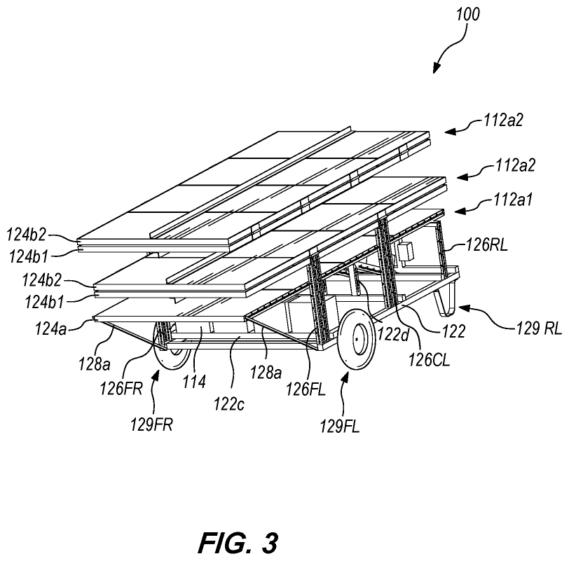

Planar-shaped support plates 122c may be mounted on elongated frame members 122a and/or support beam(s) 122b in the front and rear sections of base frame 122, respectively, to support secondary inverter 132c2 in the rear section and power storage device(s) 114 in the front section. Controller mount 122d may be embodied by a plurality of angle braces secured to one or more elongated frame member(s) 122a and/or support beam(s) 122b in the rear section of base frame 122. As illustrated in FIGS. 3 and 5, the angle braces of controller mount 122d preferably support controller 132 at an angle relative to elongated frame members 122a that improves the visibility and/or accessibility of user interface 133 from a position behind PV electricity generation unit 100.

Handle appendage(s) 122c may protrude upwardly from a rear elongated frame member 122a of base frame 122. Each handle appendage 122c may be formed separately from the rear elongated frame member 122a or contiguous with such elongated frame member 122a so as to form a unitary part thereof. Handles 127 may be respectively fastened or otherwise attached to each handle appendage 122c such that they protrude from handle appendage(s) 122c in a direction that enables them to be grasped by a user while he or she is in an upright or bent over position.

Base frame 122 may be portably supported above the ground surface by ground engaging elements 129RR, 129RL, 129FR, 129FL (ground engaging elements 129RR, 129RL, 129FR, 129FL may be collectively referred to herein as “ground engaging elements 129” when unnecessary to distinguish therebetween). In various embodiments, front ground engaging element(s) 129FR, 129FL may be configured to facilitate the mobility of base frame 122 on the ground surface, and rear ground engaging elements 129RR, 129RL may be configured to resist movement when in contact with the ground surface. For example, as shown in FIG. 4, front ground engaging element(s) 129FR, 129FL may be embodied by wheels rotatably associated respectively with front left and right sides of base frame 122, and rear ground engaging elements 129RR, 129RL may be embodied by U-shaped support legs fixedly connected respectively to rear left and right sides of base frame 122. As will be more fully described hereinafter, a user may lift the rear section of PV electricity generation unit 100 using handles 127 such that PV electricity generation unit 100 is supported on the ground surface only by the wheels, rendering it easier for the user to move across the ground surface to a desired area. Once moved to a desired area, the user may set the rear section of PV electricity generation unit 100 down such that the support legs are in contact with the ground surface to resist movement of PV electricity generation unit 100.

Intermediate frames 124 may be supported above base frame 122 by a plurality of vertical support member(s) 126RR, 126RL, 126CR, 126CL, 126FR, 126FL that are connected to, and protrude upwardly from, base frame 122. For simplicity, vertical support members 126RR, 126RL, 126CR, 126CL, 126FR, 126FL may be referred to collectively herein as “vertical support members 126” when unnecessary to distinguish therebetween. Each of vertical support members 126 may be embodied by an elongated metal, alloy, wood, or polymer bar, shaft, rod or the like (such as a steel angle) having apertures formed at spaced apart distances along its length and sufficiently sturdy to concertedly support with other vertical support members 126 the weight of intermediate frames 124 and PV array(s) 112. As shown in the embodiment of FIG. 4, vertical support members 126RL, 126CL, 126FL may protrude upwardly from the left side of base frame 122, and vertical support members 126RR, 126CR, 126FR may protrude upwardly from the right side of base frame 122. Vertical support member(s) 126 protruding from one of the left side and right side of base frame 122 are of greater length than vertical support member(s) 126 protruding from the other of the left side and right side of base frame 122. For example, vertical support members 126RL, 126CL, 126FL may each protrude upwardly from the left side of base frame 122 a distance of 30 inches, and vertical support members 126RR, 126CR, 126FR may each protrude upwardly from the right side of base frame 122 a distance of 35 inches. Such variance in the respective lengths of vertical support members 126 facilitates the foldability of intermediate frames 124 as will be more fully described hereinafter. Additionally, it is to be understood that frame assembly 120 may include any number of vertical support member(s) 126 to support intermediate frames 124 above base frame 122 so long as vertical support members 126 function to support each of intermediate frames 124 at a different distance above base frame 122.

Intermediate frames 124 are configured to support PV array(s) 112 above base frame 122. Intermediate frames 124 may include a center intermediate frame 124a and a plurality of outer intermediate frames 124b. Outer intermediate frames 124b may be characterized by primary outer intermediate frames 124b1 and supplemental outer intermediate frames 124b2. Each intermediate frame 124 may be constituted by elongated metal, alloy, or polymer bars, rails, cleats, or the like interconnected so as to form a four-sided rectangular frame shape having an open inner portion. The open inner portion of each intermediate frame 124 may be respectively sized to securely fit over the outer peripheral edges of one of outer PV array(s) 112a2 and center PV array 112a1. For example, each PV array 112 may be constituted by PV modules 112b aligned side-by-side so as to define a rectangular-shaped array measuring 44 inches in width and 104 inches in length, and each intermediate frame 124 may define an open inner portion measuring 44 inches in width and 104 inches in length so as to securely fit over the outer peripheral edges of a respective PV array 112. Each intermediate frame 124 may have a ledge that extends a distance (e.g., 1 inch) from the peripheral edges of its bottom side in an inward direction towards the center of the open inner portion. PV module(s) 114 may be secured to the ledge of intermediate frame 124, for example, by mechanical fasteners. One or more array brace(s) 124c, 124d (e.g., bars, beams or the like) may be mounted on each intermediate frame 124 so as to extend across its open inner portion to further facilitate the support of PV array(s) 112. Although intermediate frames 124 are described with regard to rectangular-shaped frames, it is contemplated that intermediate frames 124 may be embodied so as to have any number of sides, shapes, and sizes capable of supporting PV array(s) 112 as described herein.

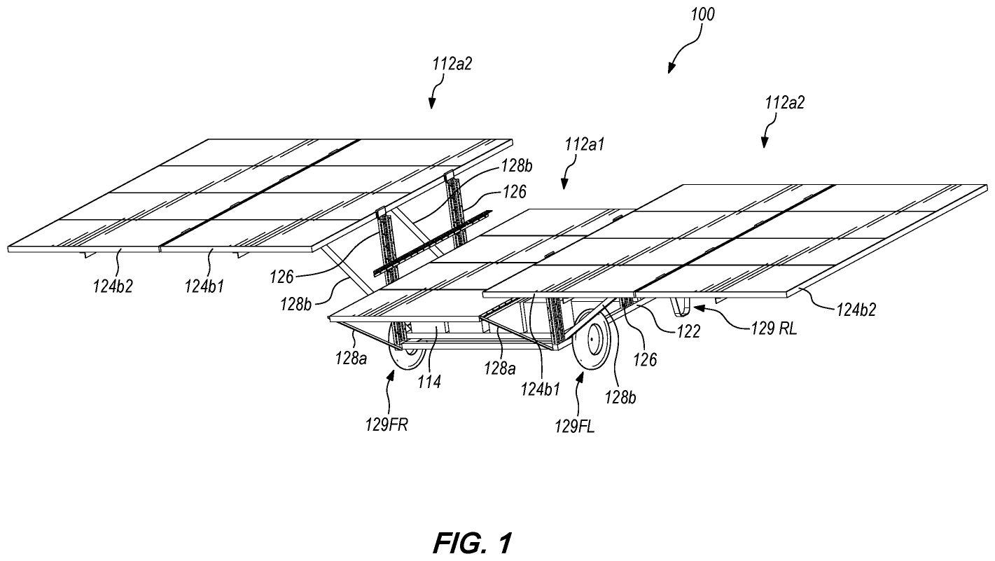

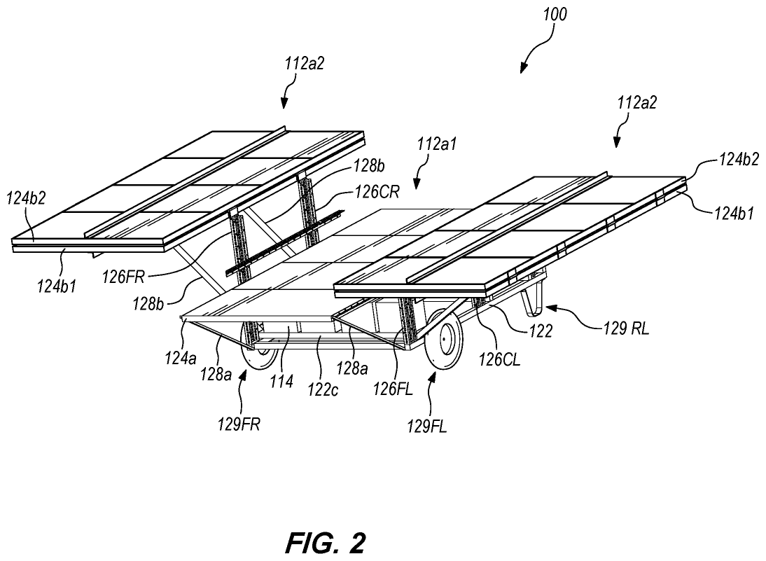

Center intermediate frame 124a may be fixedly connected to an inner surface of any or all of vertical support member(s) 126 via mechanical connectors (e.g., bolts, nuts, brackets and/or the like) such that it is supported directly or substantially directly above base frame 122 as shown in FIG. 4. Primary outer intermediate frames 124b1 may be rotatably supported on vertical support members 126 on opposite sides of center intermediate frame 124a by hinges or the like. For example, a side of one of primary outer intermediate frames 124b1 may be hingedly connected to outer surfaces of vertical support members 126FR, 126CR, and a side of the other of primary outer intermediate frames 124b1 may be hingedly connected to outer surfaces of vertical support members 126FL, 126CL. Supplementary outer intermediate frames 124b2 may be hingedly connected respectively to a side of each of primary outer intermediate frames 124b1 opposite to that which is connected to vertical support members 126. As exemplified by FIGS. 1-3 collectively, each outer intermediate frame 124b is hingedly connected such that it can be rotated relative to vertical support members 126 in a first rotational direction and a second rotational direction opposite the first rotational direction, thereby allowing it to unfold outwardly away from center immediate frame 124a and fold inwardly toward center immediate frame 124a.

FIG. 1 illustrates PV electricity generation unit 100 with intermediate frames 124 fully unfolded (which may be referred to hereinafter as the “unfolded state” of PV electricity generation unit 100). According to the embodiment of FIG. 1, when PV electricity generation unit 100 is in an unfolded state, intermediate frames 124 may be positioned substantially side-by-side such that intermediate frames 124 collectively measure about 220 inches in width. “Substantially side-by-side,” as used in the context of intermediate frames 124, may be characterized as intermediate frames 124 being directly side-by-side with the exception of spaces between intermediate frames 124 resulting from constituent elements or components that interconnect intermediate frames 124 (such as hinges and/or vertical support members 126). FIG. 3 illustrates PV electricity generation unit 100 with intermediate frames 124 fully folded (which may be referred to hereinafter as the “folded state” of PV electricity generation unit 100). According to one embodiment, when PV electricity generation unit 100 is in its folded state, intermediate frames 124 may be supported one above the other such that intermediate frames 124 collectively measure about 44 inches in width. In various embodiments, PV electricity generation unit 100 is configured such that the collective width of intermediate frames 124 in its folded state is or is about 80% less than the collective width of intermediate frames 124 when in its unfolded state. Such compactibility with respect to the width of intermediate frames 124 makes PV electricity generation unit 100 more suitable for storage in common storage areas, such as a shed or garage.

As as shown in FIG. 4, supplemental outer array support members 128 may be operably engaged with vertical support members 126 and outer intermediate frames 124b, as shown in FIG. 4, for additional support of PV array(s) 112 when PV electricity generation unit 100 is in its unfolded state. For example, each of supplemental outer array support members 128b may be embodied by an elongated bar, rod or the like removably connected at one of its ends to one of vertical support members 126CR, 126CL, 126FR, and 126FL, and, at its opposite end, to an array brace 124c of one of primary outer intermediate frames 124b1. In a preferred embodiment, supplemental outer array support members 128b may be adjustable in length. For example, supplemental outer array support members 128b may each be formed of two elongated bars slidably interconnected to extend and retract in a longitudinal direction. One bar of each supplemental outer array support member 128b, for example, may be formed to slidably fit over the outer peripheral surface(s) of the other bar of such supplemental outer array support member 128b. Various points along the length of one bar may be adapted to fixably associate with various points formed along the length of the other bar such that the length of supplemental outer array support member 128b can be selectively fixed by a user. For example, each of the bars of such supplemental outer array support member 128b may have apertures formed at various points along its length that can be aligned with apertures formed in the other bar, and a mechanical connector (such as a pin) may be inserted through the aligned apertures to fix such supplemental array support member 128b in length. As shown in FIG. 4, supplemental outer array support members 128b may be selectively fixed at sufficient lengths to support outer intermediate frames 124b at an angle perpendicular or nearly perpendicular to the longitudinal axes of vertical support members 126. Supplemental center array support members 128a may be interposed at an angle between elongated frame member(s) 122a in a front section of base frame 122 and center intermediate frame 124a to provide additional support to center intermediate frame 124a when, for example, it is supported at an angle relative to base frame 122.

A method of using an embodiment of PV electricity generation unit 100 to consistently power a primary load system of a residential building will be described hereinafter. In describing such method of use, it is presumed that PV electricity generation unit 100 is initially stored in a common storage area, such as a shed, in a folded state. PV electricity generation unit 100 is preferably used in an uncovered outdoor area exposed to sunlight. In a first step, PV electricity generation unit 100 may be positioned in the uncovered outdoor area by using handles 127 of frame assembly 120 to navigate PV electricity generation unit 100 across the ground surface on front ground engaging elements 129FL, 129FR to the uncovered outdoor area. In a second step, once positioned in the uncovered area, the local electrical distribution panel of the primary load system may be electrically connected to PV electricity generation unit 100 to receive electrical power from PV electricity generation unit 100 in the form of the primary operating power signal. In a third step, PV electricity generation unit 100 may be placed in an unfolded state to expose PV array(s) 112 of power unit 110 to photons of the sunlight by which PV array(s) 112 generate electrical power. In a fourth step, electrical power from PV array(s) 112, power storage device(s) 112, and external electrical grid 118 of power unit 110 may be output to control unit 110 in the form of power signals. In a fifth step, control unit 130 may be activated to automatically operate PV electricity generation unit 100 in various modes alternatingly based on the power signals received from power storage device(s) 114, PV array(s) 112, and external electrical grid 118.

In a sixth step, by automatically operating PV electricity generation unit 100 alternatingly in various modes, control unit 130 may generate a consistent primary operating power signal based on the power signals received from power storage device(s) 114, PV array(s) 112, and external electrical grid 118. In a seventh step, the primary load system may be powered by outputting the primary operating power signal to the local electrical distribution panel of the primary load system. When the user desires to stop using PV electricity generation unit 100 to power the primary load system, the user may deactivate control unit 130 and disconnect external electrical grid 118 and the primary load system from PV electricity generation unit 100. PV electricity generation unit 100 may then be stored by executing a method of storing the PV electricity generation unit 100 described hereinafter.

PV electricity generation unit 100 may preferably be stored in a common storage area, such as a shed or garage. In a first step, PV electricity generation unit 100 may be placed in the folded state by rotating outer intermediate frames 124b about hinges in the second rotational direction to fold them inwardly, thereby reducing the width of PV electricity generation unit 100. Once PV electricity generation unit 100 is in the folded state, in a second step, PV electricity generation unit 100 may be relocated to the common storage area by using handles 127 of frame assembly to navigate PV electricity generation unit 100 across the ground surface on front ground engaging elements 129FL, 129FR to the common storage area. In a third step, PV may be placed inside the common storage area for storage.

The principles, preferred embodiment, and various modes of operation of the present invention have been described in this specification. All references cited in this specification are hereby incorporated by reference insofar as there is no inconsistency with the disclosure of this specification. In interpreting this specification, all of the terms used to describe the present invention should be given the broadest interpretation consistent with the context. For example, the terms “comprises,” “comprising,” “includes,” “including,” and “having,” are inclusive and therefore specify the presence of stated features, modes, integers, steps, elements, operations, and/or components, but do not preclude the presence or absence of other features, modes, integers, steps, elements, operations, components, and/or groups thereof. The conjunctive term “and/or,” or terms of similar import, shall be understood to be inclusive of any and all combinations of the items listed in connection with such term. Ordinal numbers, such as “first,” “second,” and “third,” are used to distinguish between various constituent elements, operations, and/or modes for convenience and do not denote the order of constituent elements, modes, and/or operations so distinguished. Further, directional terms, such as “top,” “bottom,” “upper,” “lower,” “left,” “right,” “upward,” and “downward,” are used to clarify and describe the relationship between various constituent elements of specific embodiments of the present invention, but do not denote absolute orientation. Therefore, such terms vary according to the orientation of the present invention. In addition to the foregoing terminological considerations, specific embodiments referenced in describing the present invention are not to be regarded as exhaustive or as limiting to the full scope of the present invention. Other persons may modify the disclosed embodiments, or employ equivalents thereof, without departing from the scope and spirit of the present invention.

What is claimed is:

1. A photovoltaic electricity generation unit, comprising:
a. a frame assembly including:
i. a base frame portably supported on a ground surface by a plurality of ground engaging elements operatively associated with the base frame;
ii. one or more support members extending upwardly from the base frame;
iii. a plurality of intermediate frames foldably mounted on the one or more support members; and
iv. one or more handles configured to be grasped by a user;
b. a power unit having a plurality of power sources respectively configured to output electrical power, the plurality of power sources including at least one power storage device mounted on the base frame and at least one photovoltaic array securely fitted in the plurality of intermediate frames; and
c. a control unit having a controller accommodated inside a housing mounted on the base frame, the controller being configured to receive electrical power from the plurality of power sources of the power unit and to output AC electrical power to an AC load system based on the electrical power received from at least one of the plurality of power sources.

2. The photovoltaic electricity generation unit of claim 1, wherein the controller is configured to output AC electrical power at 120/240 VAC based on electrical power at 430 VDC received from the power unit.

3. The photovoltaic electricity generation unit of claim 3, wherein the control unit includes an electrical grid input terminal configured to electrically interconnect with an external electrical grid.

4. A frame assembly for mounting a plurality of photovoltaic modules, comprising:
a. a base frame formed by a plurality of elongated frame members interconnected to form a multi-sided frame shape;
b. a plurality of ground engaging elements operatively associated with the base frame such that the base frame is portably supported on a ground surface by the plurality of ground engaging elements;
c. a plurality of support members respectively connected to and extending upwardly from the base frame; and
d. a plurality of intermediate frames respectively mounted on at least one of the plurality of support members, the plurality of intermediate frames being configured to foldably support the plurality of photovoltaic modules.

5. The frame assembly of claim 4, wherein the plurality of intermediate frames comprises a center intermediate frame fixedly mounted to and between at least one the plurality of support members and a plurality of outer intermediate frames rotatably mounted respectively on at least one of the plurality of support members, the plurality of outer intermediate frames being configured to be rotated to and between an unfolded state and a folded state.

6. The frame assembly of claim 5, wherein each of the plurality of outer intermediate frames are a plurality of foldably interconnected multi-sided frames.

7. The frame assembly of claim 6, wherein the frame assembly further comprises at least one handle appendage provided on the base frame and a plurality of handles protruding from the at least one handle appendage in a direction in which the plurality of handles are graspable by a user.

8. The frame assembly of claim 7, wherein the plurality of ground engaging elements include a plurality of front ground engaging elements constituted by wheels rotatably associated with a front left side and a front right side of the base frame, and a plurality of rear ground engaging elements constituted by support legs fixedly connected to a rear left side and a rear right side of the base frame, the support legs being configured to resist movement when in contact with a ground surface.
